(19) United States
(12) Patent Application Publication
(10) Pub. No.: US 2004/0188967 A1
(43) Pub. Date: Sep. 30, 2004

(54) Laminated skateboard

(76) Inventor: Geoffrey Gallo, Las Vegas, NV (US)

Correspondence Address: Geoffrey Gallo, 6637 West Hyde Avenue, Las Vegas, NV, 89107, US

(21) Appl. No.: 10/805,524

(22) Filed: Mar. 19, 2004

Related U.S. Application Data
(60) Provisional application No. 60/456,658, filed on Mar. 24, 2003.

(51) Int. Cl. B62M 1/00

(52) U.S. Cl. 280/87.041; 280/87.042

(57) ABSTRACT

An improved skateboard deck and method of making the same consisting of laminations of wood, Non-wood, (First Quality Carbon Fiber (Warp Direction) & Kevlar Hybrid Fabric) & (Kevlar Fabric) and Metal (Titanium Strips). The lamination of the three or more materials, one material being wood, the other material being non-wood ply's and another material being metal constructed and positioned precisely according to design specifications and placed in accordance to their respective lengths and widths according to their exact determined length and widths and the order in which the materials are placed will structurally enhance the laminated wood skateboard deck. With the combination of the combined materials with their physical properties being so different and placed between the wood ply's in their respective placement and order will yield a superior final product, being a laminated skateboard which is safer, lighter, stronger and more flexible, virtually more unbreakable than any previous wood and non-wood designed skateboard.

### REFERENCES CITED

U.S. Patent Documents

| | | | |
|---|---|---|---|
| 3173161 | March., 1965 | Amsbry | 280/609. |
| 3707296 | December., 1972 | Palazzolo et al | 280/610. |
| 4140326 | Febuary., 1979 | Huber | 280/87. |
| 4295656 | October., 1981 | Moore | 280/87. |
| 4697821 | October., 1987 | Hayashi et al | 280/609. |
| 4972868 | December., 1990 | Morris | 280/609. |
| 5005853 | April., 1991 | Lampl | 280/610. |
| 5080382 | January., 1992 | Franz | 280/87. |
| 5238260 | August., 1993 | Scherubl | 280/610. |
| 5320378 | June., 1994 | Wiig | 280/610 |
| 6059307 | May., 2000 | Western | 280/609. |
| 6182986 | Febuary., 2001 | Smith | 280/87.042. |

### BACKGROUND TO THE INVENTION

Since the invention of the skateboard, skateboarding has been growing widely and steadily in popularity. Skateboarders have been steadily performing more aggressively. Maneuvers and tricks have been increasing intricately in technical difficulty.

A very important consideration in the development of the skateboard deck has been to make stronger, lighter and more resilient decks. It is widely known that the skateboard deck has been constructed of layers of wood ply laminations, along with the construction of placing cores of fiberglass, other materials and cores covered with fiberglass. These attempts have been to lighten and improve the strength of the skateboard deck. The purpose of these improvements is to enable the skateboarder to continually improve his or her ability in performing maneuvers.

Skateboard decks are continually exposed to high impact stress. Due to this impact stress, skateboard decks are continually breaking. The integrity of the deck is constantly being breached, and as a result of this, skateboarders are being forced to purchase skateboard decks more often and are being exposed to serious injury.

Known prior art includes U.S. Pat. No. 3,844,576; U.S. Pat. No. 4,412,687; U.S. Pat. No. 4,523,772; U.S. Pat. No. 5,005,853; U.S. Pat. No. 5,649,717: U.S. Pat. No. 5,759,664; U.S. Pat. No. 5,803,478; U.S. Pat. No. 5,855,389; U.S. Pat. No. 6,182,986.

While these U.S. Patents probably fulfill their respective objectives and requirements, the aforementioned patents do not produce a skateboard deck that is lighter, stronger and more resilient for the skateboarder all at the same time.

In this respect, the skateboard deck in this new construction placement formula substantially increases the strength, resilience and lightens the overall skateboard deck with the resiliency and strength being the focus of the invention.

### SUMMARY OF INVENTION

This is an improved method of constructing a skateboard deck provided for all uses of a skateboard with the primary focus of the fundamental improvements being first in the performance and the endurance of the skateboard deck. This improved skateboard deck will allow for the skateboarder to more aggressively perform maneuvers without having to constantly consider the ability of the skateboard deck to perform without a serious breach in the integrity of the deck.

One of the primary objectives of this innovative design is to improve the strength, endurance and resiliency of the skateboard deck. Eliminating wood plies and replacing the wood plies with layers of First Quality Carbon Fiber/Kevlar Hybrid Woven Fabric along with precise placement of Titanium Strip (s) accomplishes this. By installing these non-wood materials precisely according to the design on top and in between the wood plies increases the overall skateboard deck strength and resiliency and to reduce and or eliminate the possibility of the deck snapping.

Another objective of this design is to lighten the overall skateboard deck, thus enabling the skateboarder to more easily perform the intricate maneuvers being attempted each time the skateboarder gets on his or her skateboard. This will also allow the professional and amateur skateboarders to continually create new and more technical maneuvers so as to further progress the sport.

And still another objective, which is obtained by this design, is the direct application of Hook's Law, (which states specifically that if an applied force separates or causes to separate the molecules to the extent that they are unable to return to their original positions, the material is permanently deformed or broken apart). Wherein the exact placement of the non-wood material, specifically, the First Quality Carbon Fiber/Kevlar Hybrid Woven Fabric and the Titanium Strip (s), creates the design feature that wherein the final product produces a continuous spring effect. This spring effect is created by the placement of the Titanium Strip (s) exactly in the center of the skateboard deck laminations exactly centered over, along side and between the truck placement drill holes for the truck bolts. By applying Newton's Second Law, the placement of the Titanium Strips in this location, in combination with the First Quality Carbon Fiber/Kevlar Hybrid Woven Fabric, (when the applied force, the product of mass and velocity; symbol p, units kg.m/s; a vector quantity. ‘Force equals the rate of change of momentum with time, an essential principle in physics) the impact, which is the weight of the skateboarder that creates the load which is placed on the skateboard deck, the load being the impact of the skateboarders weight which occurs when the skateboarder performs maneuvers that places the load of the skateboarder on either end or in the center of the skateboard deck, the Titanium Strips working in conjunction with the bolts of the trucks helps prevent the skateboard deck from being brought to the limit of the skateboard deck's elasticity, therefore preventing the skateboard deck's integrity from being breached. These Titanium Strips and First Quality Carbon Fiber/Kevlar Hybrid Fabric in combination substantially increase the overall strength and resiliency of the skateboard deck and in doing so also lighten the skateboard deck.

### DETAILED DESCRIPTION

Exactly what I am doing is adding high tech high strength components to the already established process to laminating a skateboard deck. What precisely is being done is placing at strategic locations of the skateboard deck after determination based on the width and length of the skateboard deck by the formula: (p/2×3−L+1 wherein “p” is the number of wood layers and “L” is the overall length of said skateboard deck, the width of the non-wood layers for skateboard decks with four and five layers of wood being determined by the formula w/3×2+1 wherein “w” is the overall width of said skateboard deck and the width of non-wood layers for skateboard decks with six or more layers of wood being determined by the formula w/3×2−1 wherein “w” is the overall width of said skateboard deck.) This formula determines the length and width of the carbon fibre/kevlar hybrid fabric. What we then do is to make a cartridge by using epoxy that encases the fabric so that adhesion is possible when placing these cartridges between or on top of the laminated wood plys. Then the normal laminating process is then completed. Because of the high tensile strength of the fabric the application of Hooks Law takes affect (which states specifically that if an applied force separates or causes to separate the molecules to the extent that they are unable to return to their original positions, the material is permanently deformed or broken apart). I also add a strip of Titanium Metal in the center of the skateboard deck during the laminating process, (Refer to the FIGS. T-1 thru T-5) When this process is completed and the holes are drilled for the truck mounting, the drill holes go directly thru the titanium metal. When the trucks are mounted the skateboard becomes even stronger. As the rider stresses the skateboard deck the titanium works in conjunction with the truck bolts to prevent the skateboard deck from reaching it point of breach.

### BRIEF DESCRIPTION OF THE DRAWINGS

FIG. 1 represents a center cross-section side view of deck design 1 showing the five layers of wood and four layers of non-wood material and the order of their placement.

FIG. 2 represents a center cross-section side view of deck design 2 showing the six layers of wood and three layers of non-wood material and the order of their placement.

FIG. 3 represents a center cross-section side view of deck design 3 showing the seven layers of wood and two layers of non-wood material and the order of their placement.

FIG. 4 represents a center cross-section side view of deck design 4 showing the seven layers of wood and two layers of non-wood material and the order of their placement.

FIG. 5 represents a center cross-section side view of deck design 5 showing the five layers of wood and two layers of non-wood material and order of their placement and the layer, in which the Titanium strips are placed, see FIG. T-1.

FIG. 6 represents a center cross-section side view of deck design 6 showing the five layers of wood and three layers of non-wood material and the order of their placement.

FIG. 7 represents a center cross-section side view of deck design 7 showing the six layers of wood and two layers of non-wood material and the order of their placement.

FIG. 8 represents a center cross-section side view of deck design 8 showing the six layers of wood and two layers of non-wood material and the order of their placement.

FIG. 9 represents a center cross-section side view of deck design 9 showing the six layers of wood and two layers of non-wood material and the order of their placement.

FIG. 10 represents a center cross-section side view of deck design 10 showing the five layers of wood and two layers of non-wood material and order of their placement and the layer, in which the Titanium strips are placed, see FIG. T-1.

FIG. 11 represents a center cross-section side view of deck design 11 showing the five layers of wood and two layers of non-wood material and order of their placement and the layer, in which the Titanium strips are placed, see FIG. T-2.

FIG. 12 represents a center cross-section side view of deck design 12 showing the four layers of wood and three layers of non-wood material and order of their placement and the layer, in which the Titanium strips are placed, see FIG. T-2.

FIG. 14 represents a center cross-section side view of deck design 14 showing the seven layers of wood and two layers of non-wood material and the order of their placement.

FIG. 15 represents a center cross-section side view of deck design 15 showing the four layers of wood and three layers of non-wood material and order of their placement and the layer, in which the Titanium strips are placed, see FIG. T-2.

FIG. 16 represents a center cross-section side view of deck design 15 showing the four layers of wood and three layers of non-wood material and order of their placement and the layer, in which the Titanium strips are placed, see FIG. T-2.

FIG. 17 represents a center cross-section side view of deck design 17 showing the four layers of wood and three layers of non-wood material and order of their placement and the layer, in which the Titanium strips are placed, see FIG. T-2.

FIG. 18 represents a center cross-section side view of deck design 18 showing the five layers of wood and two layers of non-wood material and the order of their placement.

FIG. 19 represents a center cross-section side view of deck design 19 showing the six layers of wood and two layers of non-wood material and order of their placement and the layer, in which the Titanium strips are placed, see FIG. T-1.

FIG. 20 represents a center cross-section side view of deck design 20 showing the six layers of wood and two layers of non-wood material and order of their placement and the layer, in which the Titanium strips are placed, see FIG. T-2.

FIG. 21 represents a center cross-section side view of deck design 21 showing the six layers of wood and two layers of non-wood material and order of their placement and the layer, in which the Titanium strip is placed, see FIG. T-3.

FIG. 22 represents a center cross-section side view of deck design 22 showing the six layers of wood and two layers of non-wood material and order of their placement and the layer, in which the Titanium strips are placed, see FIG. T-5.

FIG. 23 represents a center cross-section side view of deck design 23 showing the six layers of wood and two layers of non-wood material and order of their placement and the layer, in which the Titanium strip are placed, see FIG. T-4.

FIG. 24 represents a center cross-section side view of deck design 24 showing the five layers of wood and two layers of non-wood material and order of their placement and the layer, in which the Titanium strip are placed, see FIG. T-4.

FIG. 25 represents a center cross-section side view of deck design 25 showing the five layers of wood and two layers of non-wood material and order of their placement and the layer, in which the Titanium strips are placed, see FIG. T-5.

FIG. 26 represents a center cross-section side view of deck design 26 showing the five layers of wood and two layers of non-wood material and order of their placement and the layer, in which the Titanium strips is placed, see FIG. T-1.

FIG. 27 represents a center cross-section side view of deck design 27 showing the five layers of wood and two layers of non-wood material and order of their placement and the layer, in which the Titanium strips is placed, see FIG. T-2.

FIG. 28 represents a center cross-section side view of deck design 28 showing the five layers of wood and two layers of non-wood material and order of their placement and the layer, in which the Titanium strip is placed, see FIG. T-3.

FIG. 29 represents a center cross-section side view of deck design 29 showing the five layers of wood and two layers of non-wood material and order of their placement and the layer, in which the Titanium strip is placed, see FIG. T4.

FIG. 30 represents a center cross-section side view of deck design 30 showing the five layers of wood and two layers of non-wood material and order of their placement and the layer, in which the Titanium strips is placed, see FIG. T-1.

FIG. 31 represents a center cross-section side view of deck design 31 showing the five layers of wood and two layers of non-wood material and order of their placement and the layer, in which the Titanium strip is placed, see FIG. T-2.

FIG. 32 represents a center cross-section side view of deck design 32 showing the five layers of wood and two layers of non-wood material and order of their placement and the layer, in which the Titanium strip is placed, see FIG. T-3.

FIG. 33 represents a center cross-section side view of deck design 33 showing the five layers of wood and one layer of non-wood material and order of its placement and the layers in which the Titanium strips are placed between, see FIG. T-1.

FIG. 34 represents a center cross-section side view of deck design 34 showing the five layers of wood and two layers of non-wood material and order of it's placement and the layers in which the Titanium strip are placed between, see FIG. T-4.

FIG. 35 represents a center cross-section side view of deck design 35 showing the five layers of wood and one layer of non-wood material and order of its placement and the layers in which the Titanium strips are placed between, see FIG. T-5.

FIG. 36 represents a center cross-section side view of deck design 36 showing the five layers of wood and one layer of non-wood material and order of its placement.

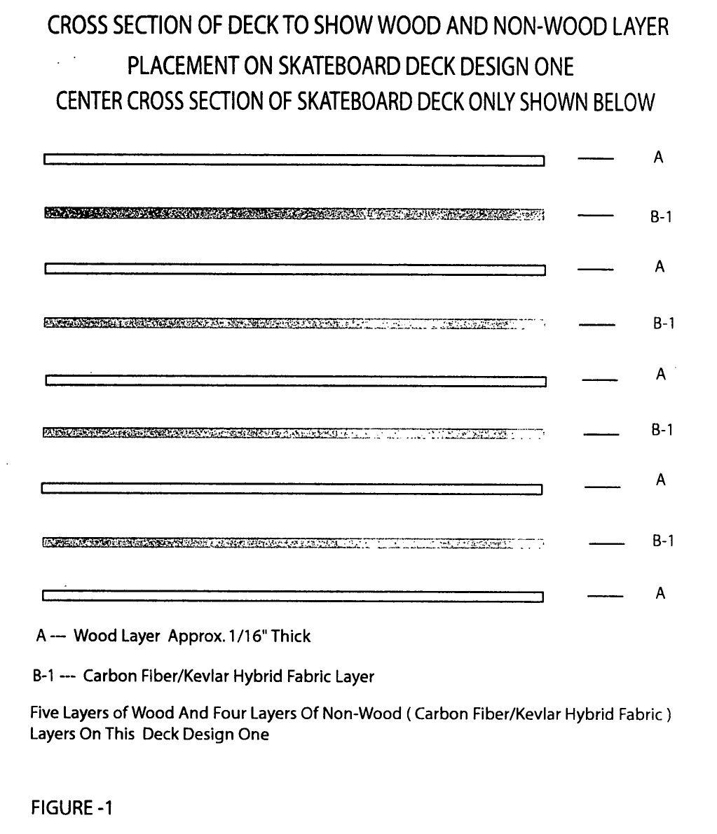

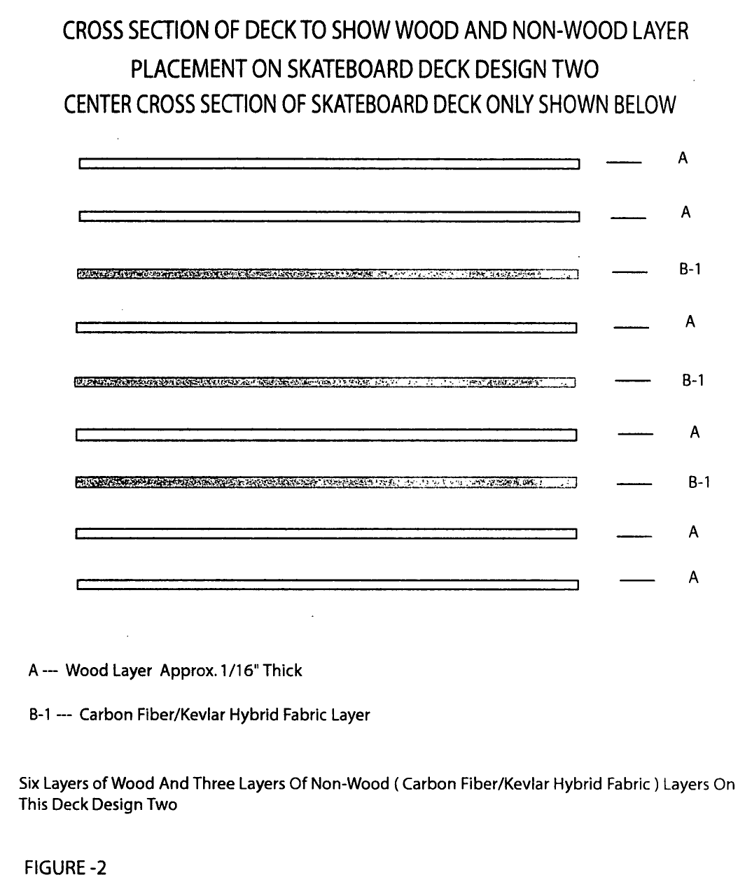

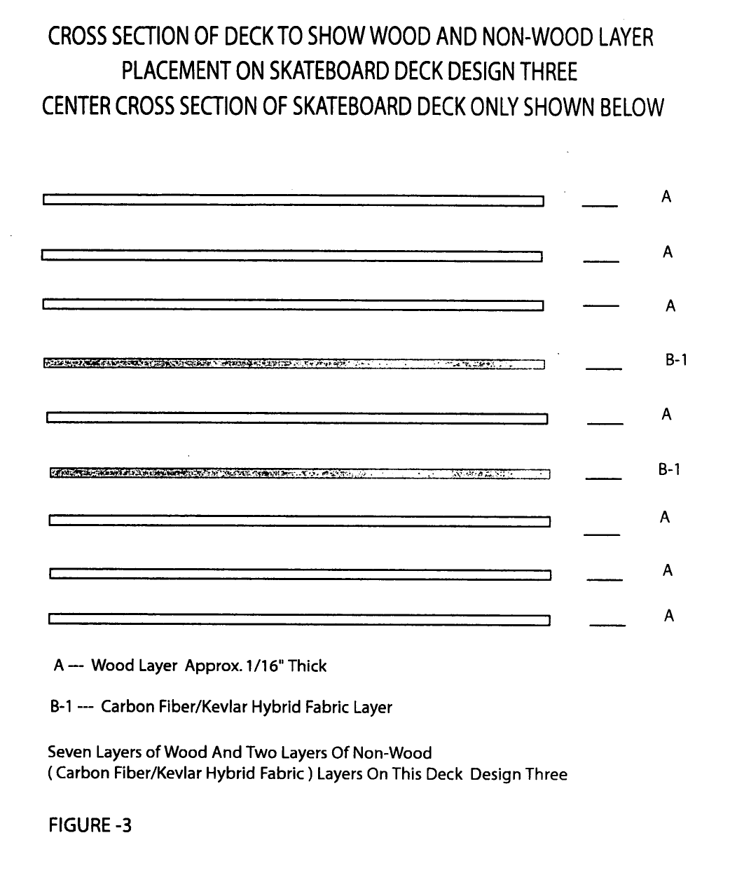

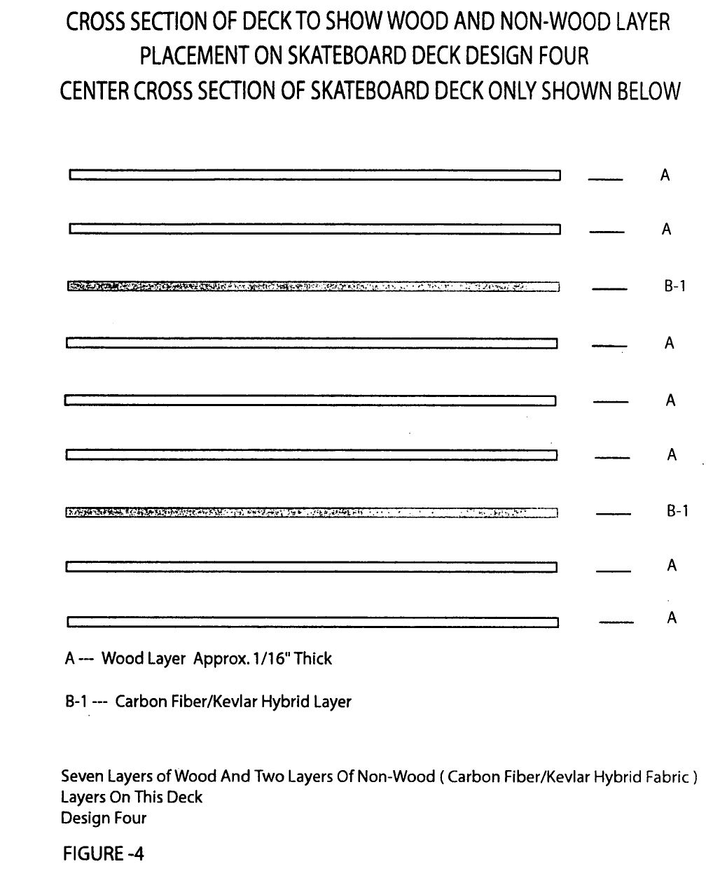

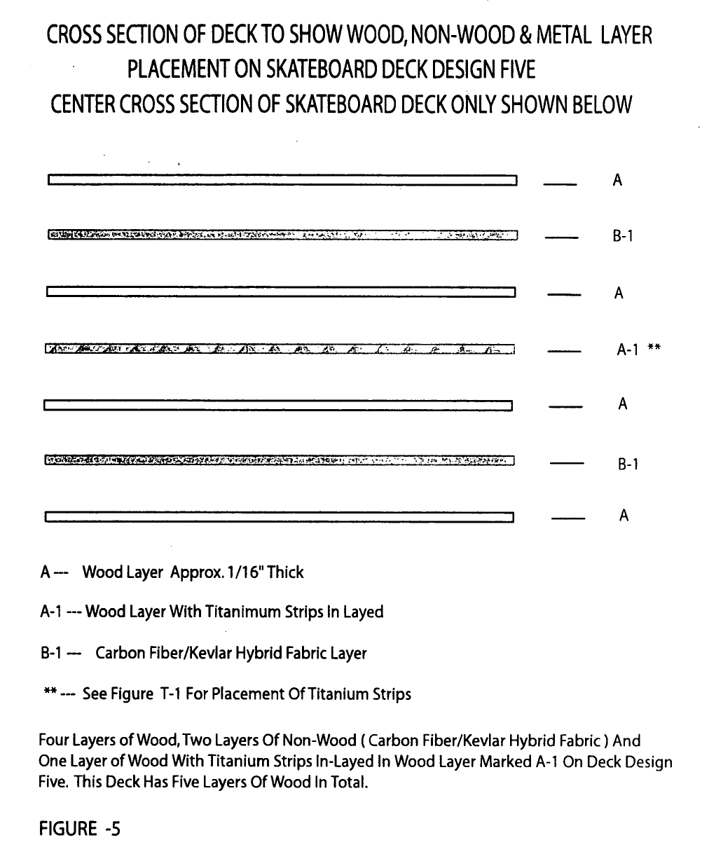

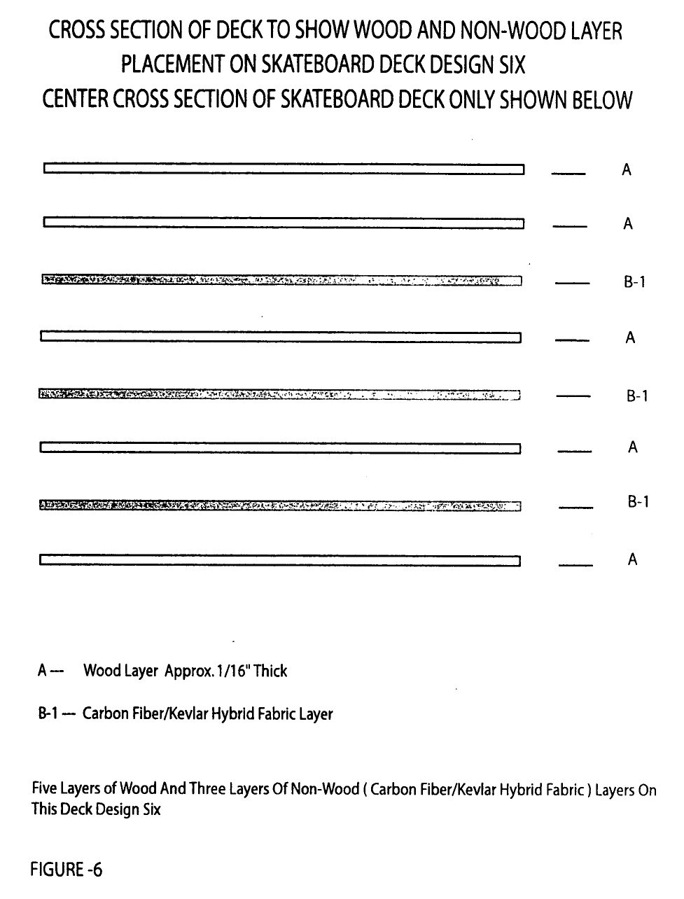

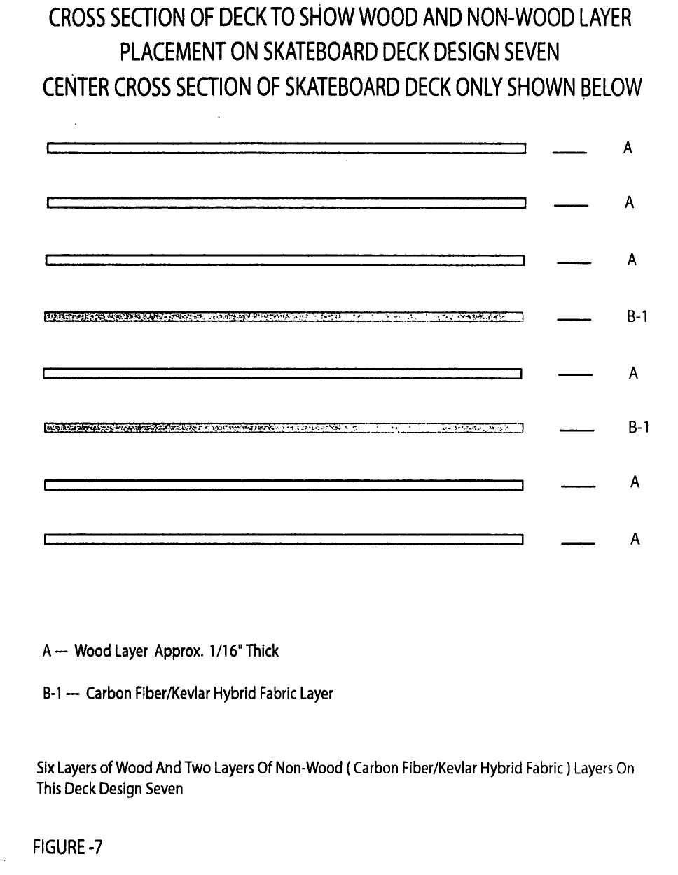

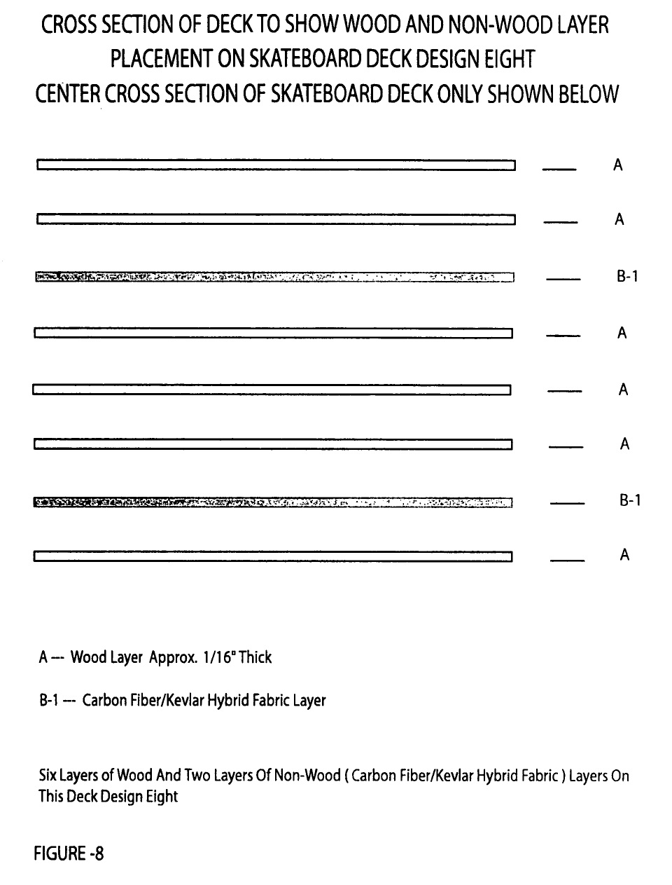

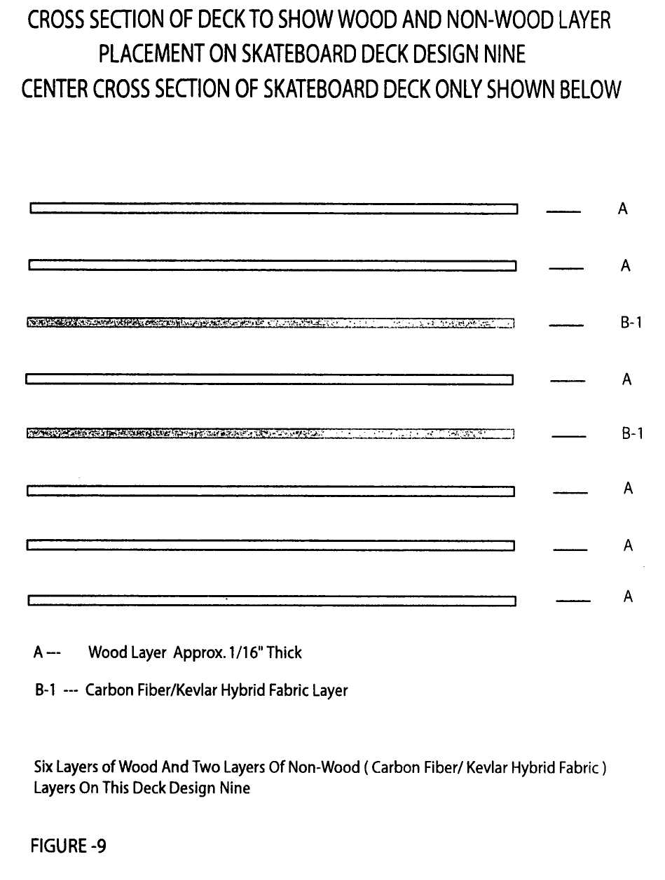

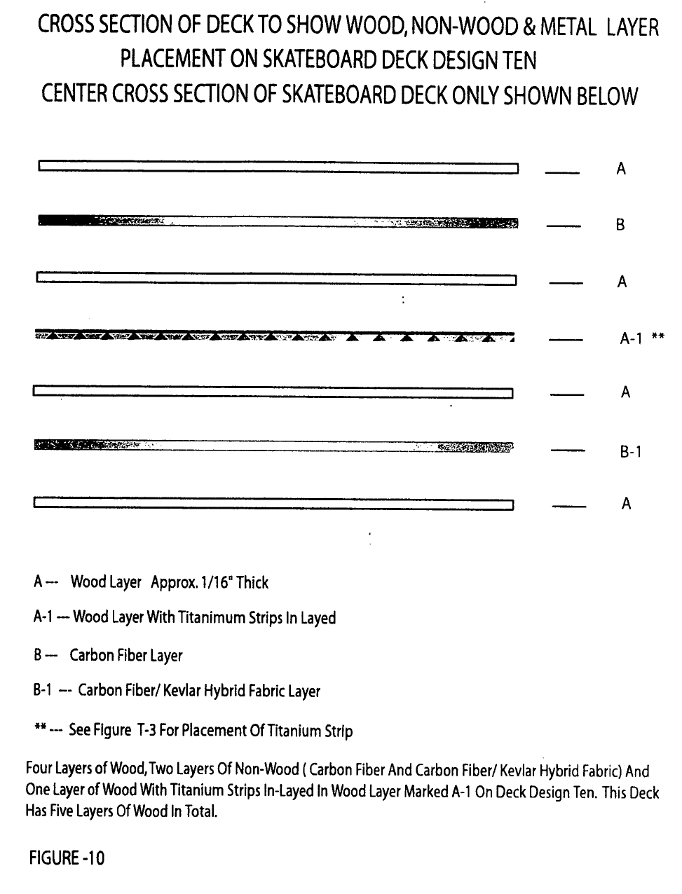

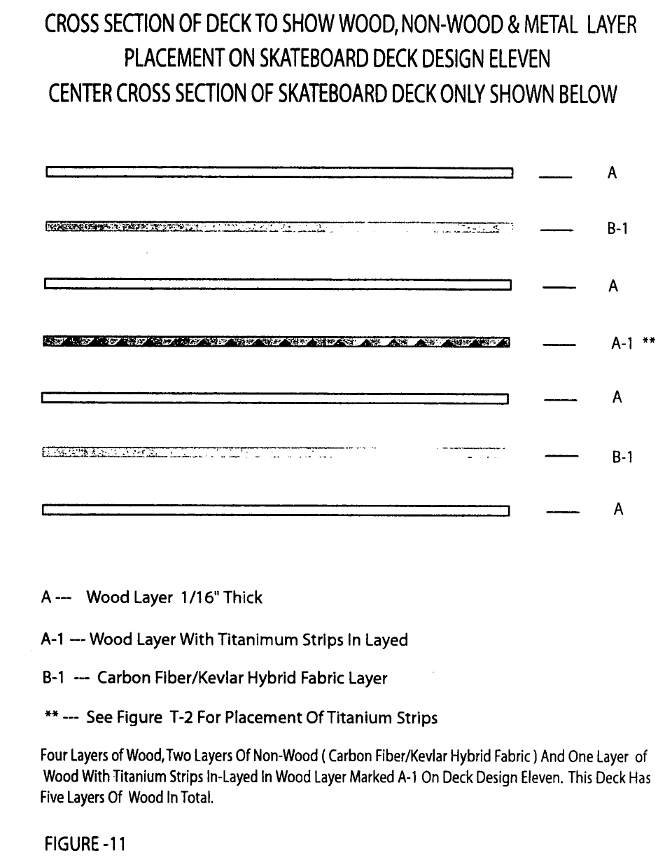

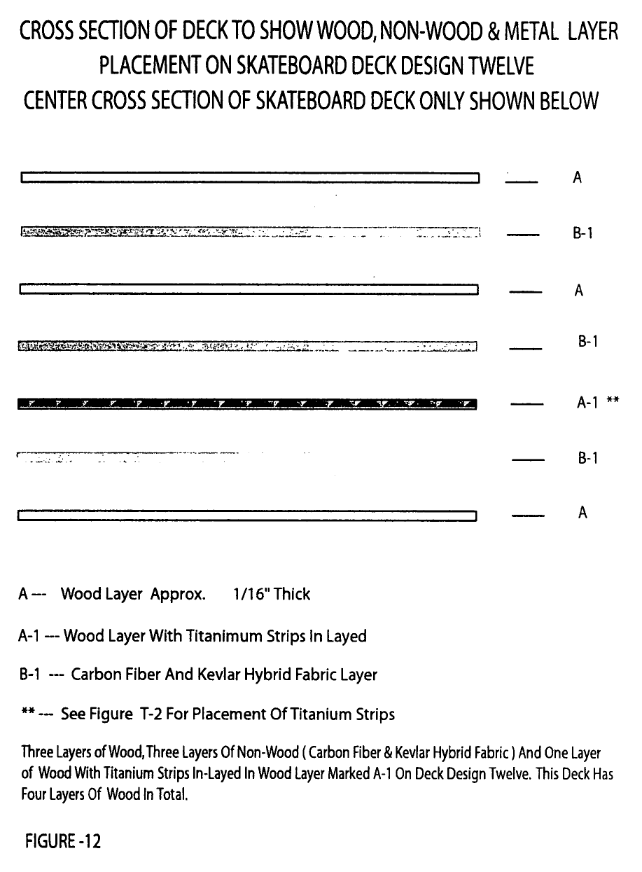

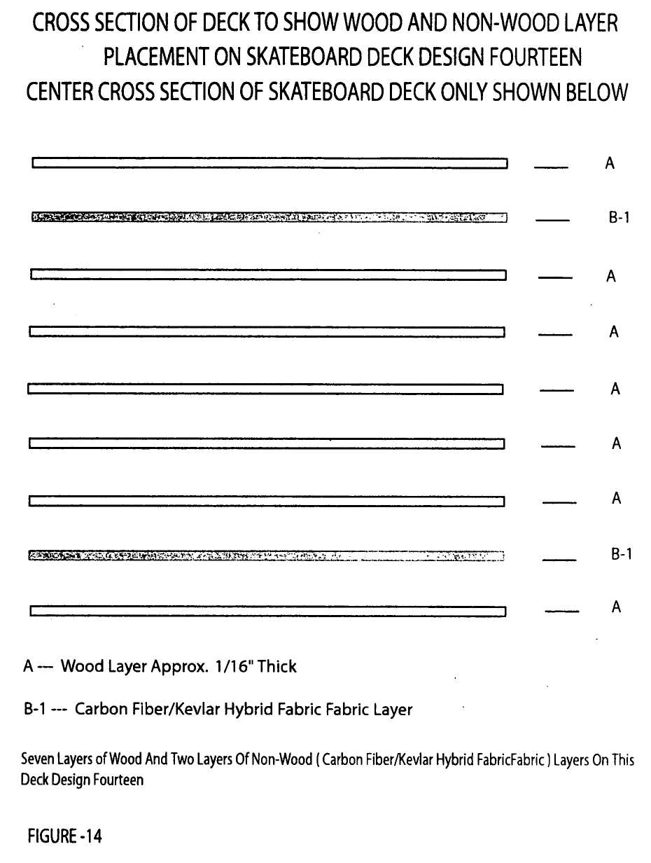

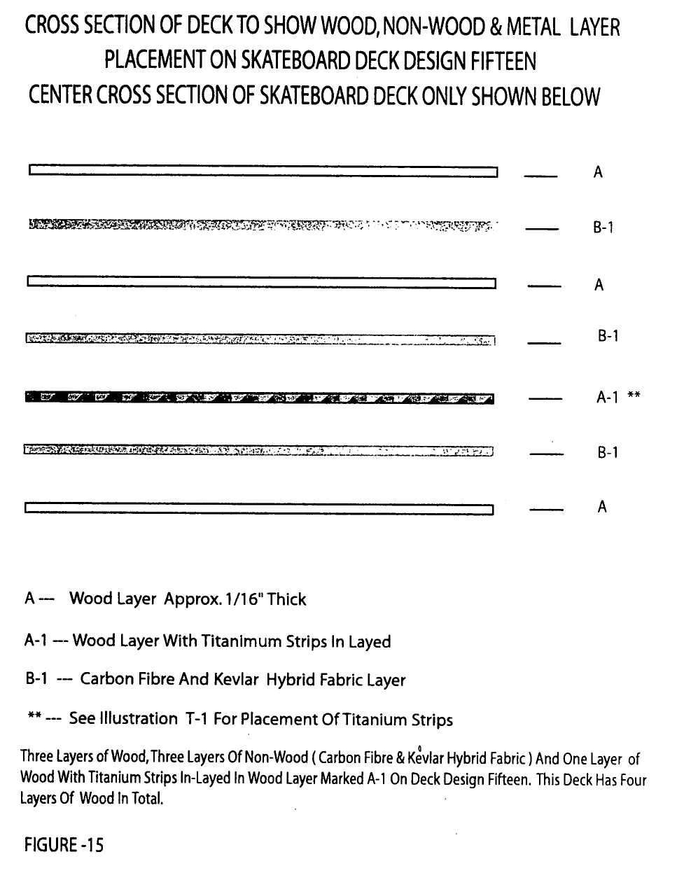

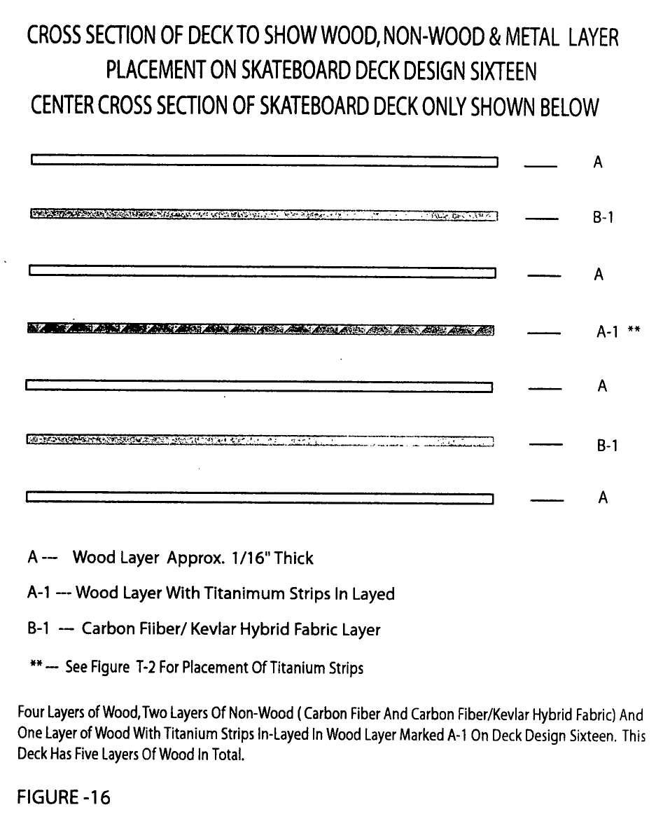

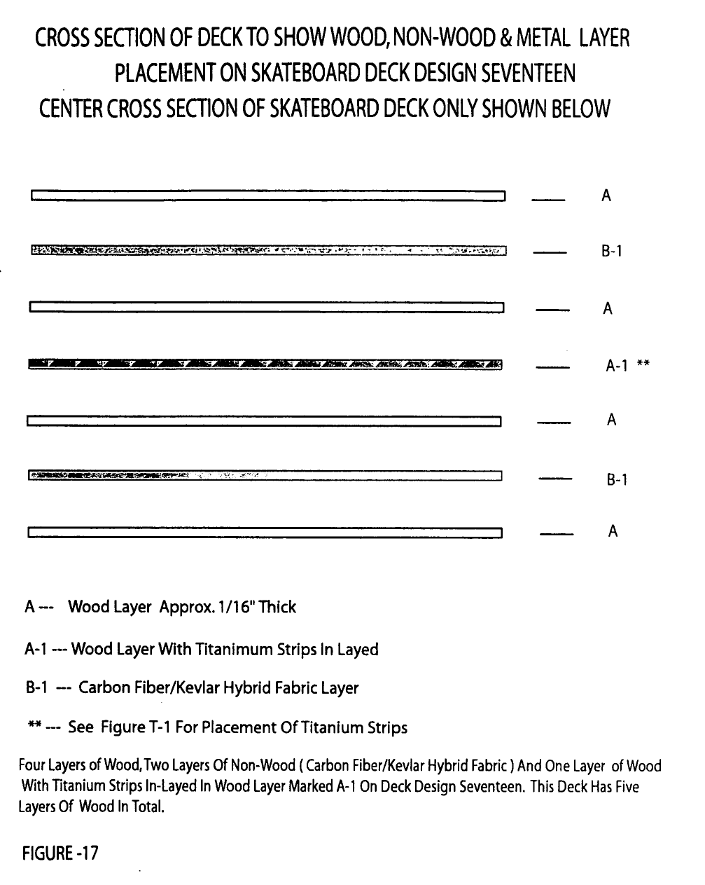

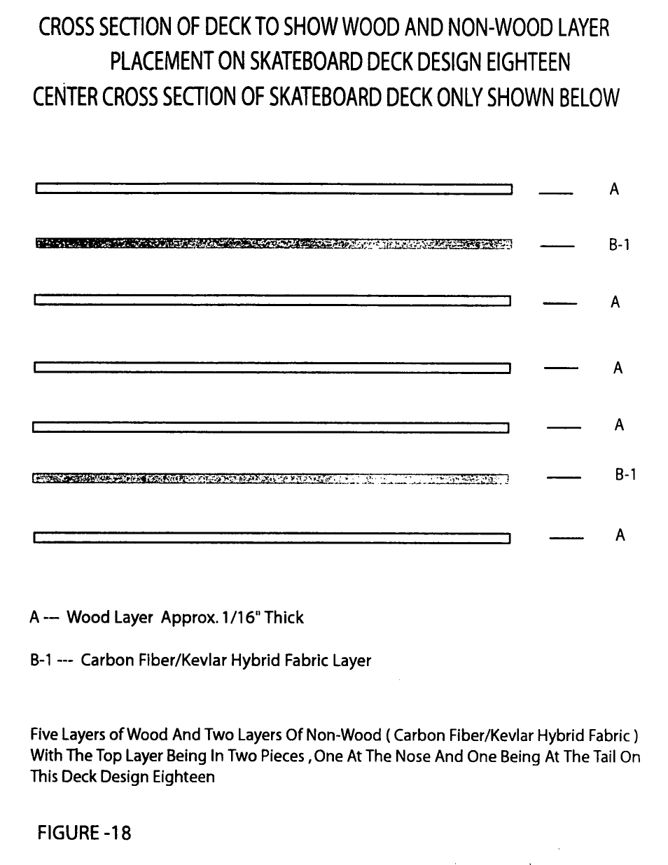

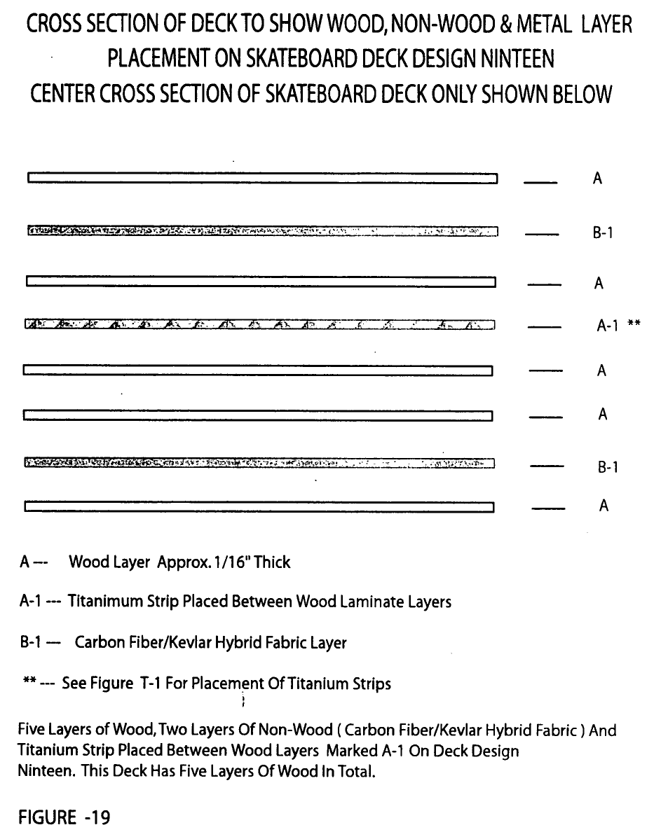

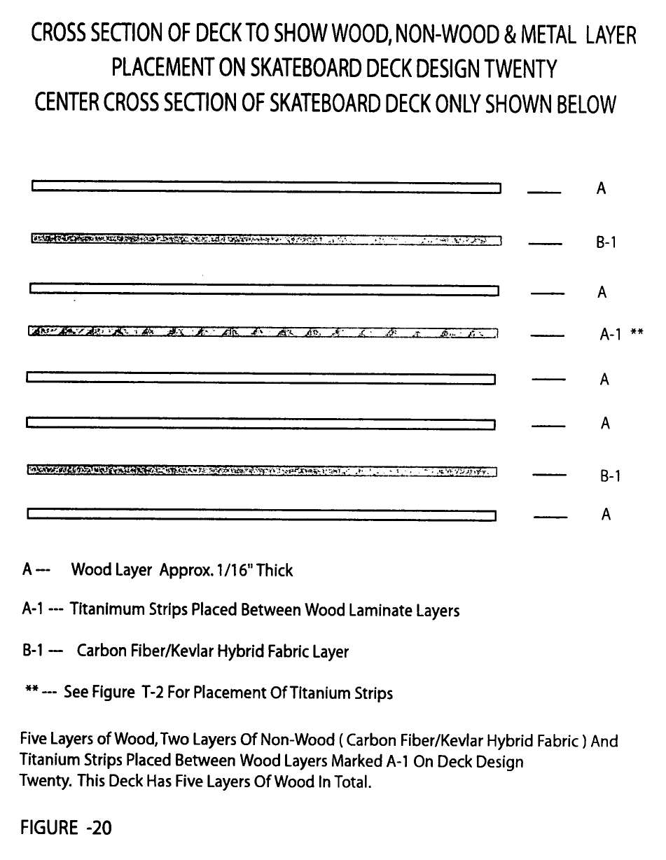

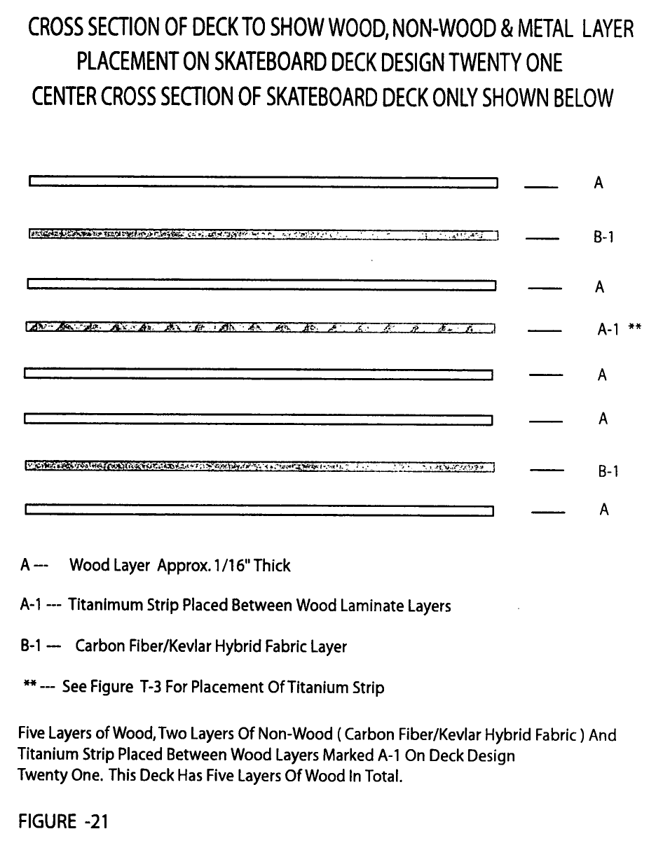

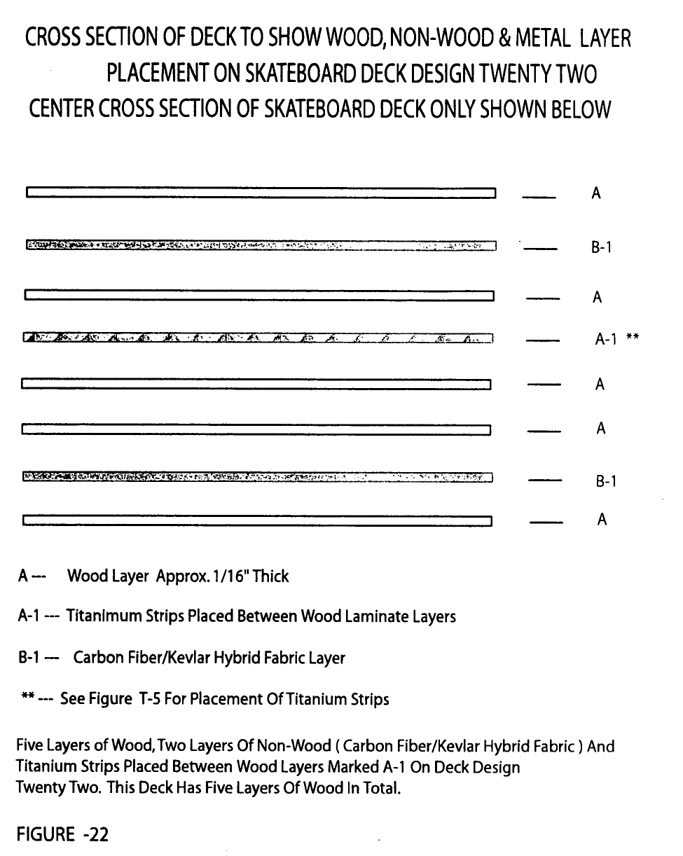

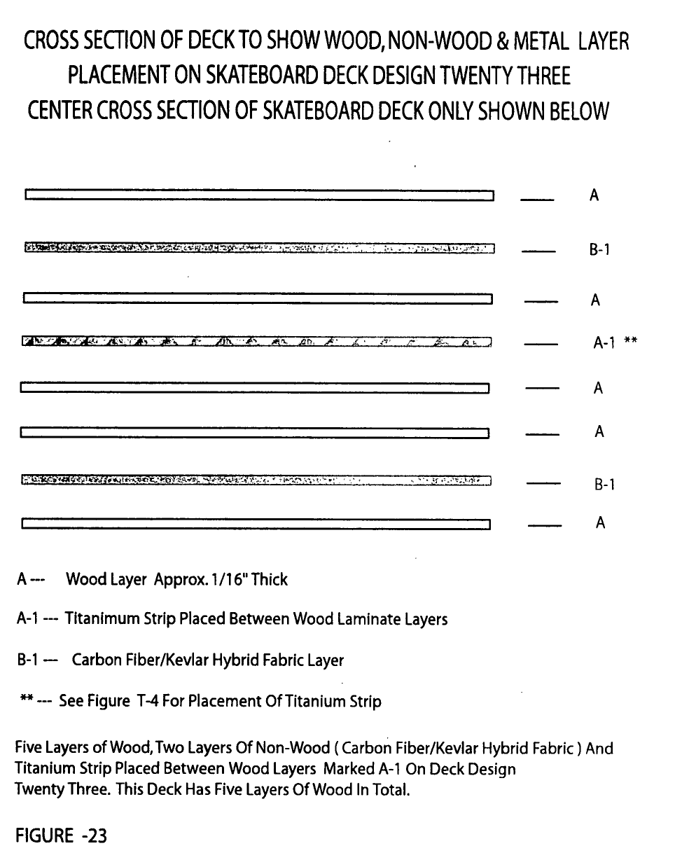

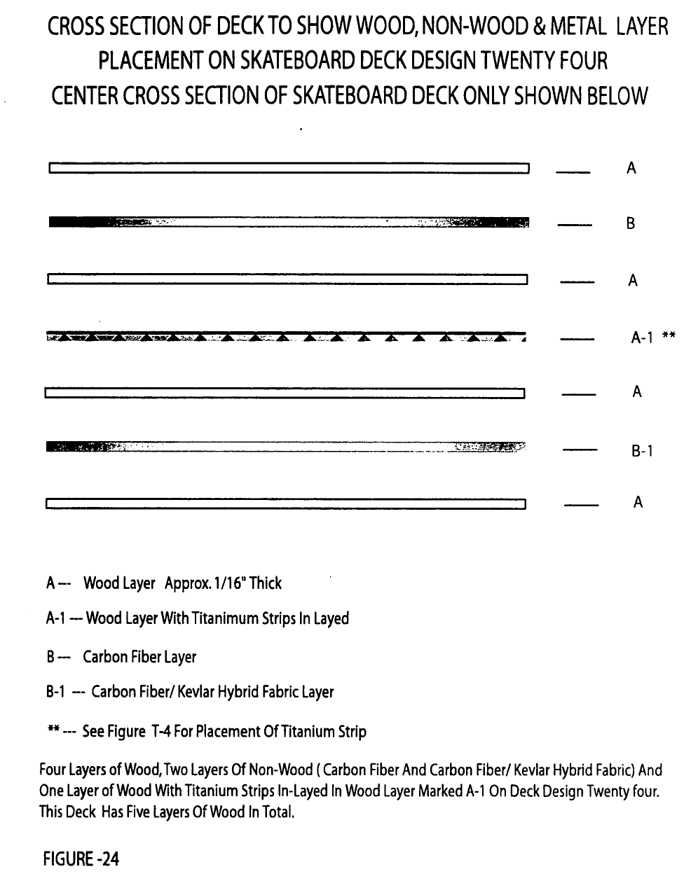

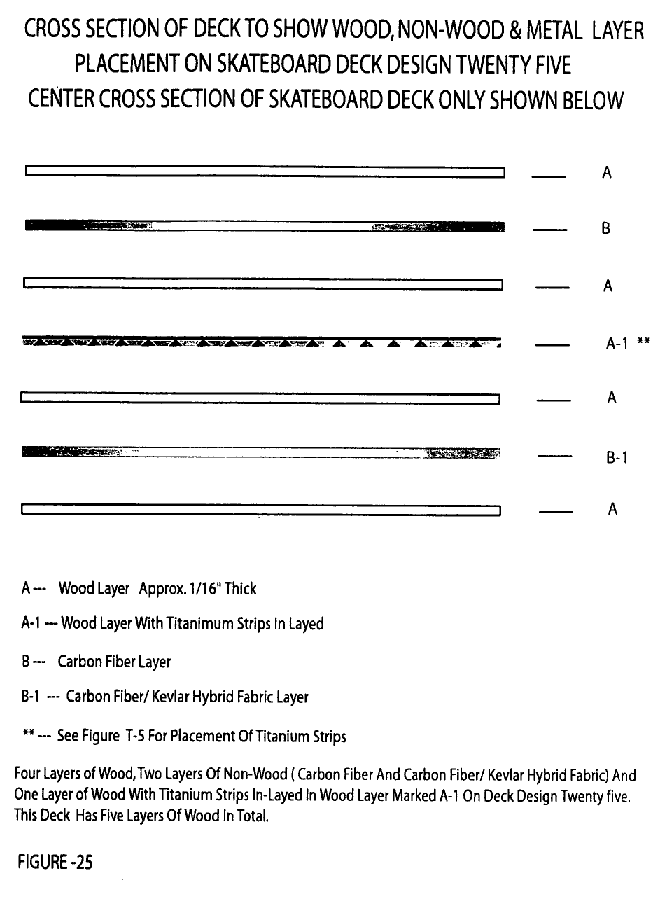

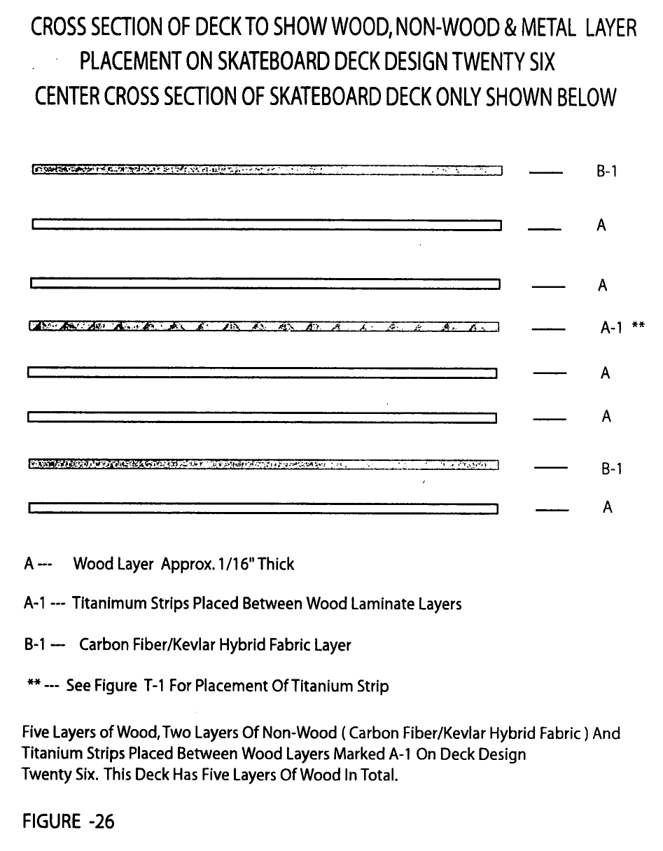

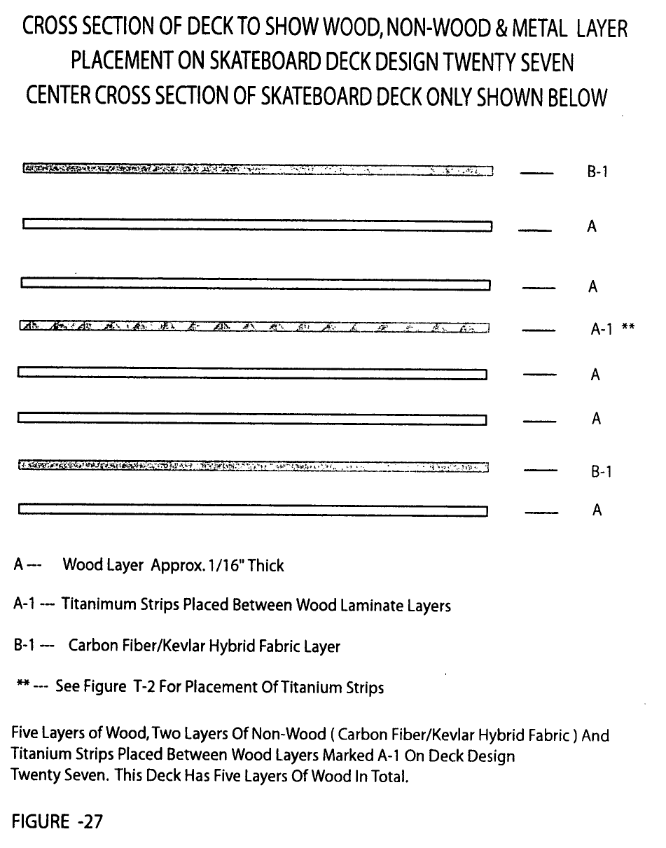

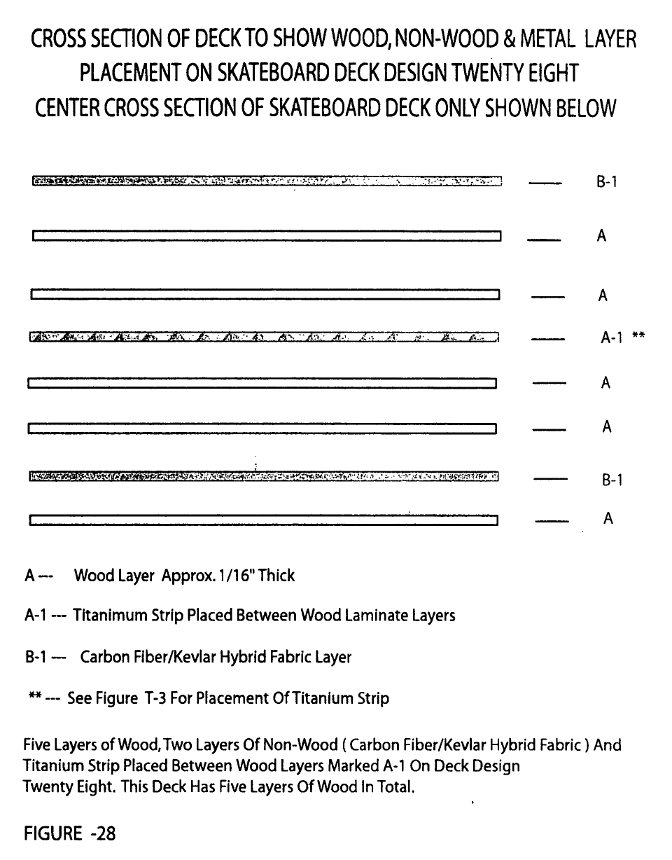

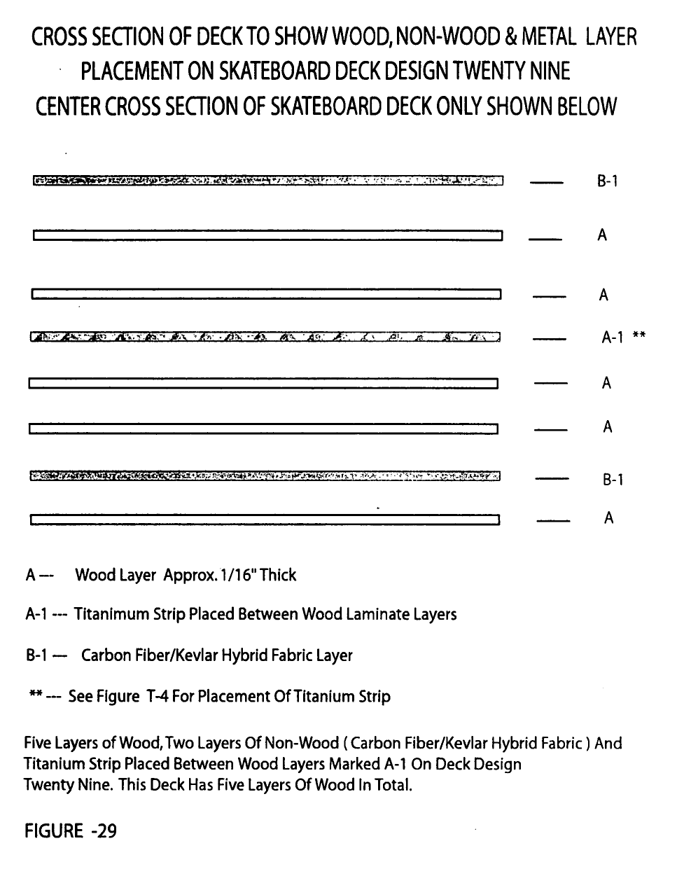

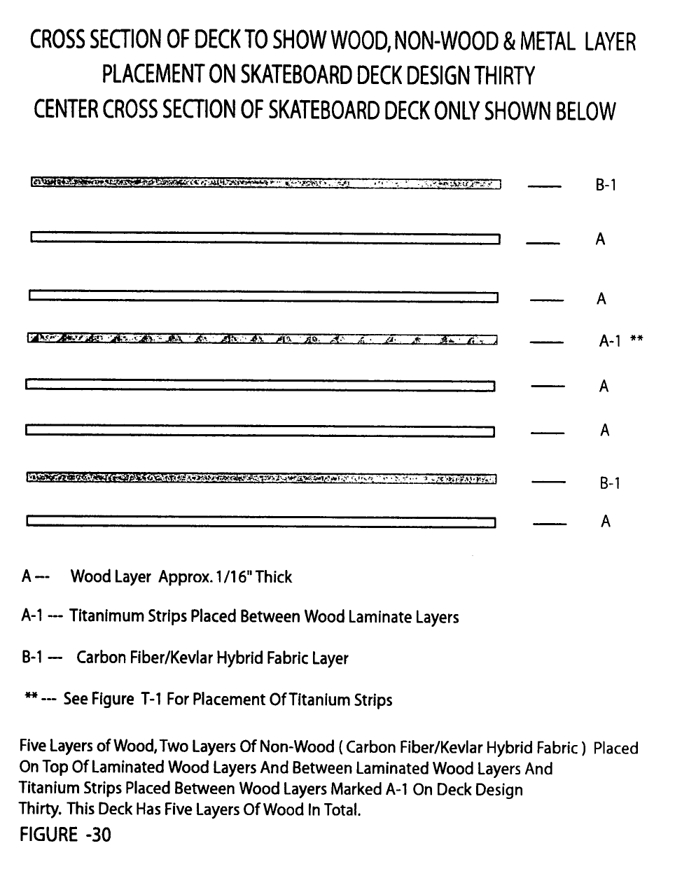

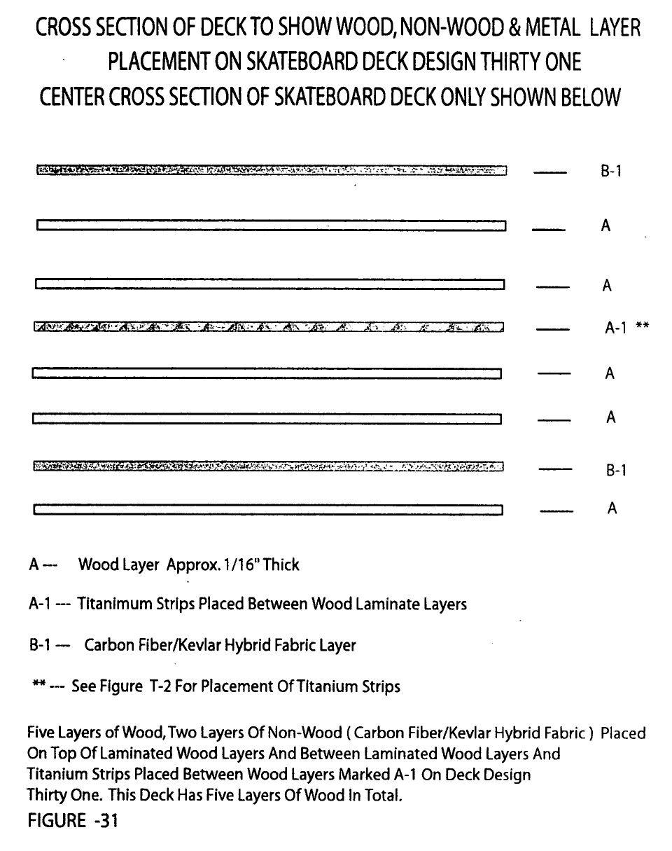

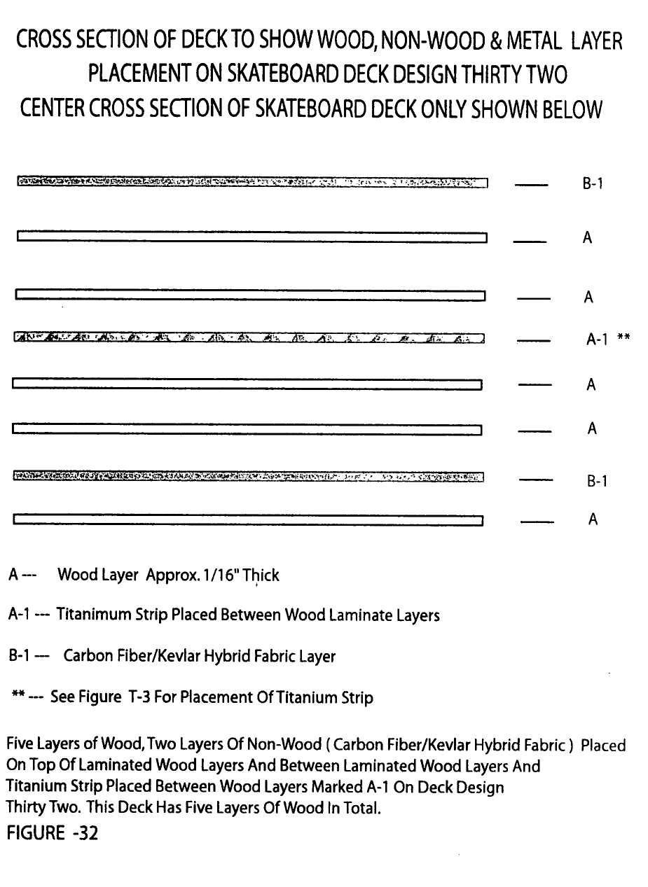

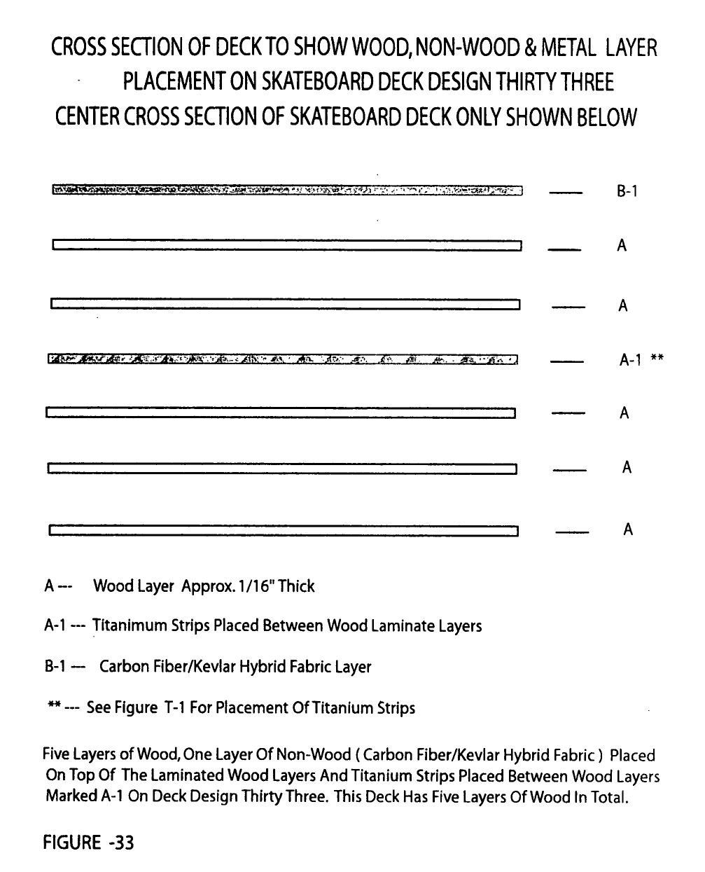

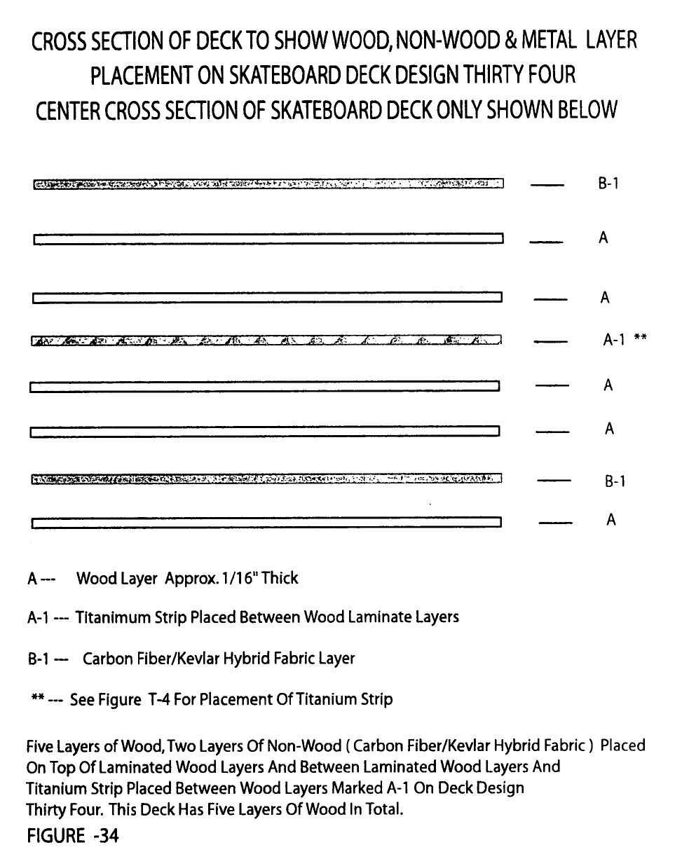

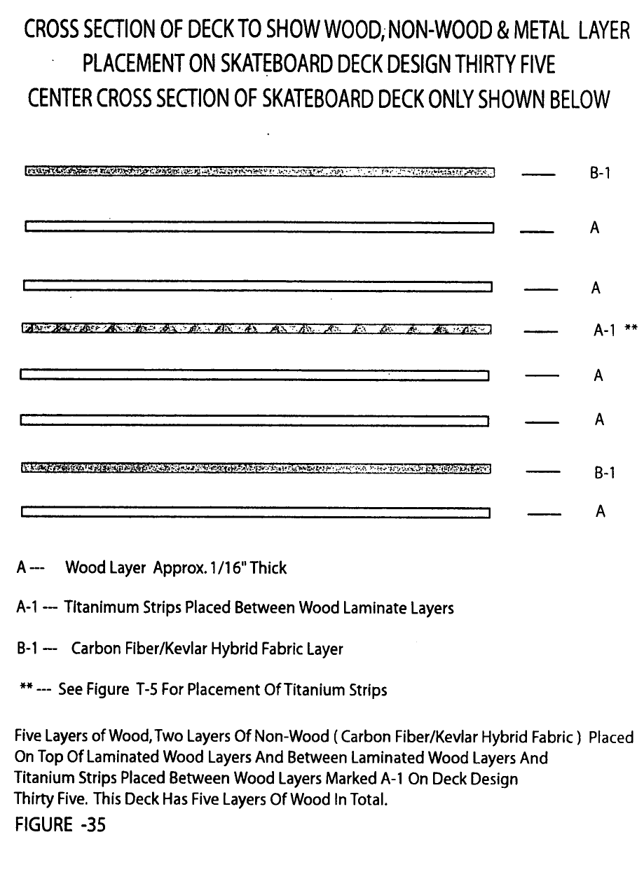

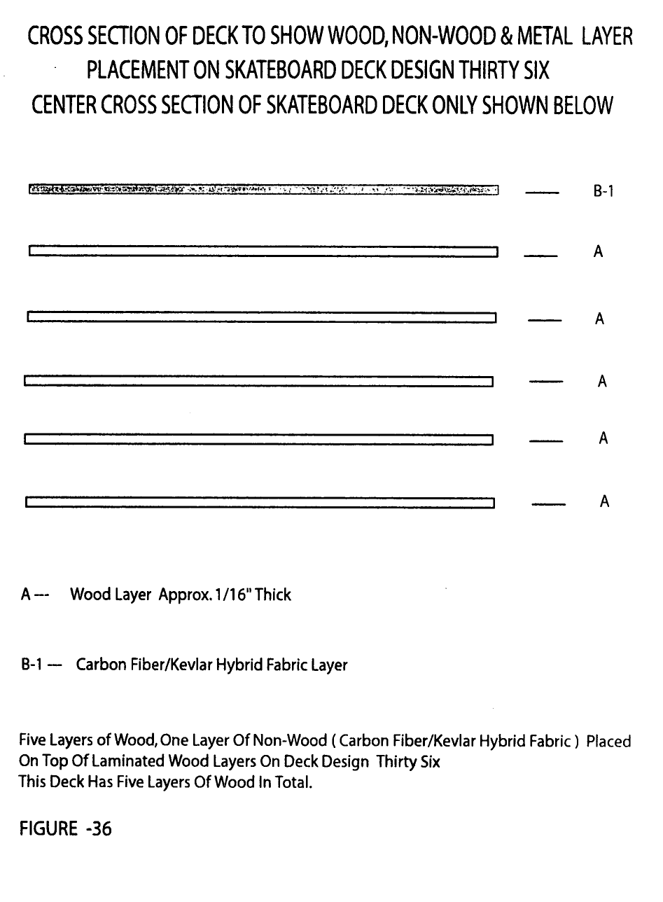

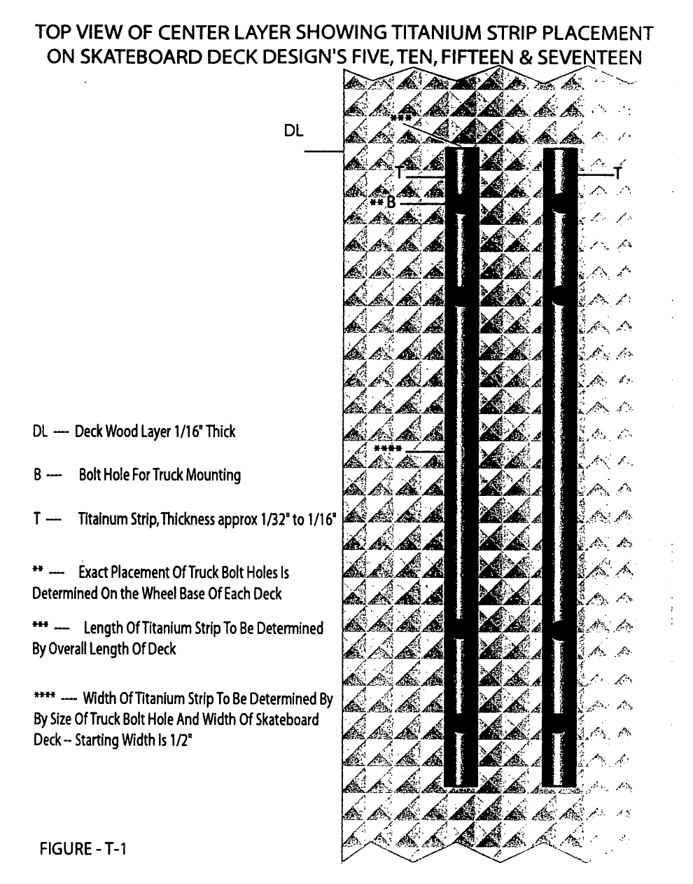

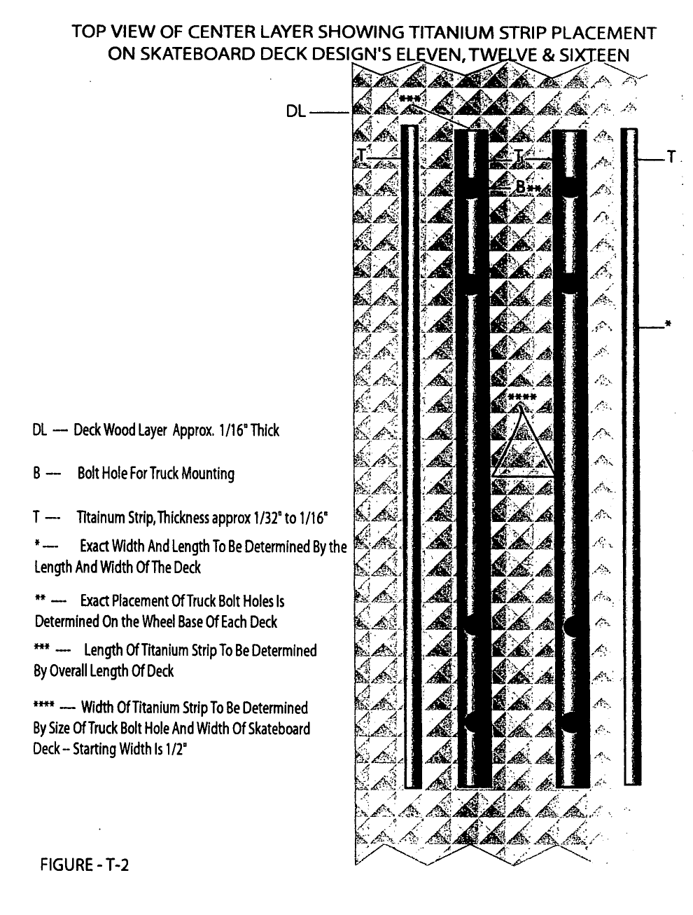

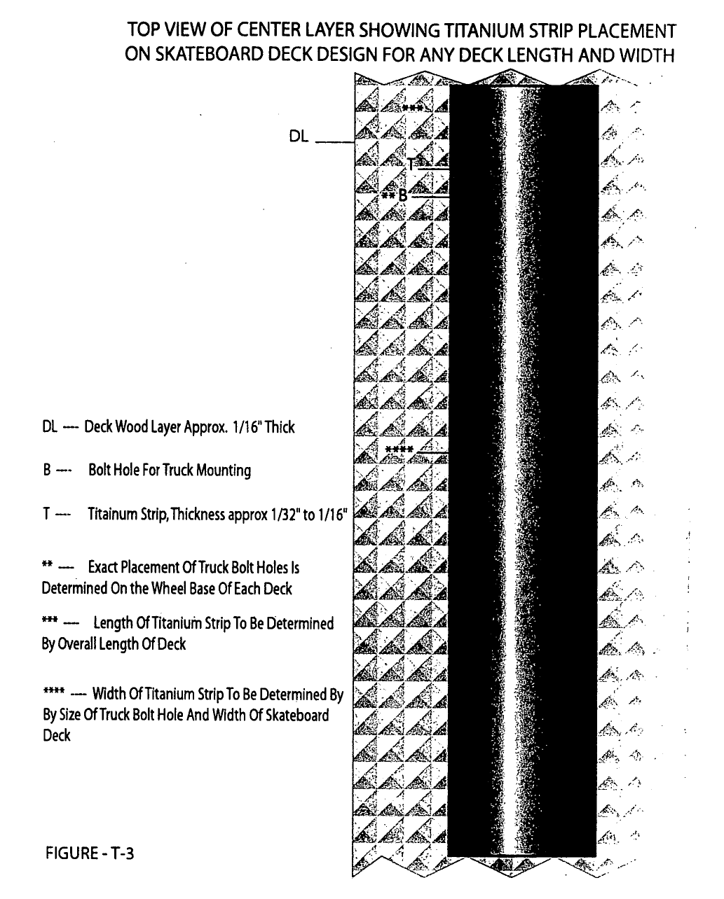

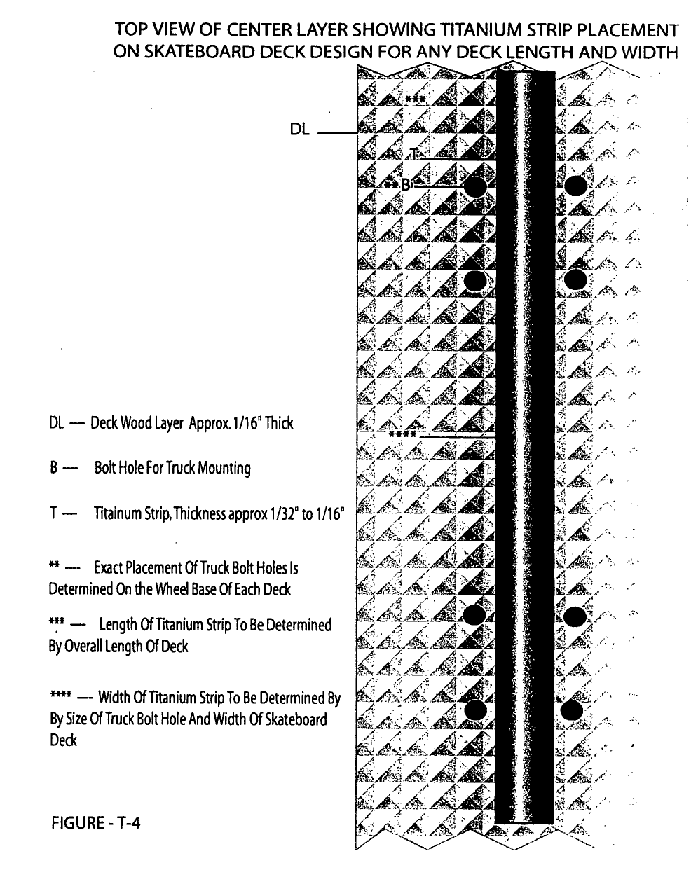

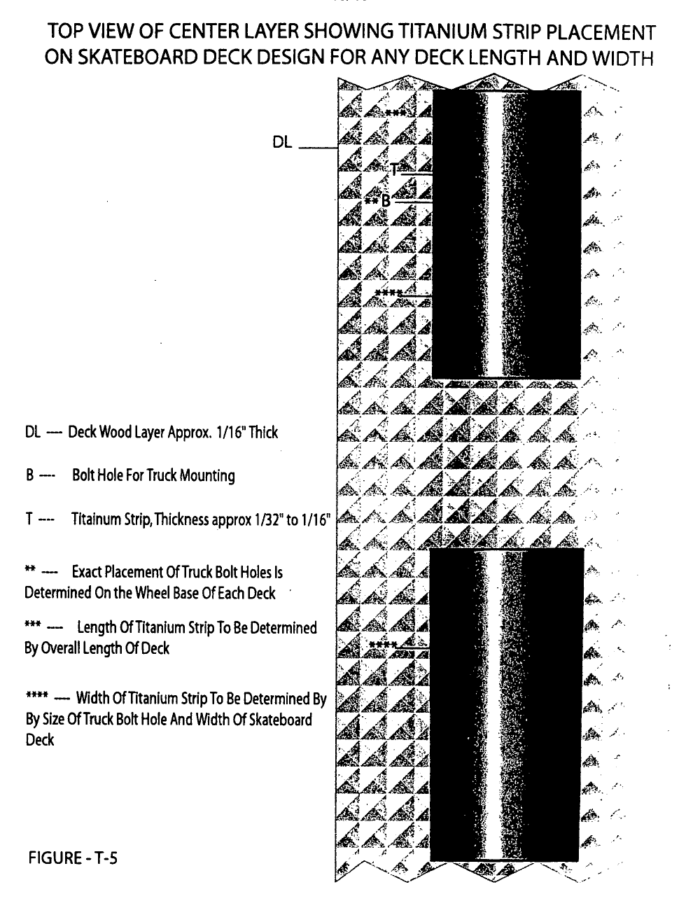

FIG. T-1 represents a cross section top view of the laminated layer, which has two Titanium Strips, installed.

FIG. T-2 represents a cross section top view of the laminated layer, which has four Titanium Strips, installed.

FIG. T-3 represents a cross section top view of the laminated layer, which has one Titanium Strip, installed.

FIG. T-4 represents a cross section top view of the laminated layer, which has one Titanium Strip, installed.

FIG. T-5 represents a cross section top view of the laminated layer, which has two Titanium Strips, installed.

What I claim is:

1. A skateboard deck comprising of plural stacked wood ply laminate layers, non-wood layers, said skateboard deck having a center axis with said non-wood layers being centered over said center axis and being placed between the wood layers when laminated, the length of non-wood layers being determined by the formula: p/2×3−L+1 wherein “p” is the number of wood ply layers and “L” is the overall length of said skateboard deck, the width of the non-wood layers for skateboard decks with four and five layers of wood being determined by the formula w/3×2+1 wherein “w” is the overall width of said skateboard deck and the width of non-wood layers for skateboard decks with six or more layers of wood being determined by the formula w/3×2−1 wherein “w” is the overall width of said skateboard deck.

2. A skateboard deck, as recited in claim 1, wherein each wood ply layer is less than or greater than or equal to 1/16″ thick.

3. A skateboard deck, as recited in claim 1, wherein each said non-wood layer is comprised of first quality Carbon Fiber/Kevlar Hybrid Fabric.

4. A skateboard deck comprising of plural stacked wood ply laminate layers, non-wood layers and metal strip (s), said skateboard deck having a center axis with said non-wood layers being centered over said center axis and being placed between the wood layers when laminated, the length of non-wood layers being determined by the formula: p/2×3−L+1 wherein “p” is the number of wood layers and “L” is the overall length of said skateboard deck, the width of the non-wood layers for skateboard decks with four and five layers of wood being determined by the formula w/3×2+1 wherein “w” is the overall width of said skateboard deck and the width of non-wood layers for skateboard decks with six or more layers of wood being determined by the formula w/3×2−1 wherein “w” is the overall width of said skateboard deck.

5. A skateboard deck, as recited in claim 4, wherein each wood ply layer is less than or greater than or equal to 1/16″ thick.

6. A skateboard deck, as recited in claim 4, wherein each said non-wood layer is comprised of first quality Carbon Fiber/Kevlar Hybrid Fabric.

7. A skateboard deck, as recited in claim 4, wherein each said non-wood metal strip (s) is comprised of titanium.

8. A skateboard deck comprising of plural stacked wood ply laminate layers, non-wood layers and metal strip (s), said skateboard deck having a center axis with said non-wood layers being centered over said center axis and being placed between the wood layers when laminated, the length of non-wood layers being determined by the formula: p/2×3−L+1 wherein “p” is the number of wood layers and “L” is the overall length of said skateboard deck, the width of the non-wood layers for skateboard decks with four and five layers of wood being determined by the formula w/3×2+1 wherein “w” is the overall width of said skateboard deck and the width of non-wood layers for skateboard decks with six or more layers of wood being determined by the formula w/3×2−1 wherein “w” is the overall width of said skateboard deck.

9. A skateboard deck, as recited in claim 8, wherein each wood ply layer is less than or greater than or equal to 1/16″ thick.

10. A skateboard deck, as recited in claim 8, wherein each said non-wood layer is comprised of first quality Carbon Fiber/Kevlar Hybrid Fabric.

11. A skateboard deck comprising of plural stacked wood ply laminate layers, non-wood layers, said skateboard deck having a center axis with said non-wood layers being centered over said center axis and being placed on top or between the wood layers when laminated, the length of non-wood layers being determined by the formula: p/2 ×3−L+1 wherein “p” is the number of wood layers and “L” is the overall length of said skateboard deck, the width of the non-wood layers for skateboard decks with four and five layers of wood being determined by the formula w/3×2+1 wherein “w” is the overall width of said skateboard deck and the width of non-wood layers for skateboard decks with six or more layers of wood being determined by the formula w/3×2−1 wherein “w” is the overall width of said skateboard deck.

12. A skateboard deck, as recited in claim 11, wherein each wood ply layer is less than or greater than or equal to 1/16″ thick.

13. A skateboard deck, as recited in claim 11, wherein each said non-wood layer is comprised of first quality Carbon Fiber/Kevlar Hybrid Fabric.

14. A skateboard deck comprising of plural stacked wood ply laminate layers, non-wood layers and metal strip(s) said skateboard having a center axis with said non-wood layers being centered over said center axis and being placed between the wood layers when laminated, the length of non-wood layers being determined by the formula: p/2 ×2−L+1 wherein “p” is the number of wood layers and “L” is the overall length of said skateboard deck, the width of the non-wood layers for skateboard decks with four and five layers of wood being determined by the formula w/3×2+1 wherein “w” is the overall width of said skateboard deck and the width of non-wood layers for skateboard decks with six or more layers of wood being determined by the formula w/3×2−1 wherein “w” is the overall width of said skateboard deck.

15. A skateboard deck, as recited in claim 14, wherein each wood ply layer is less than or greater than or equal to 1/16″ thick.

16. A skateboard deck, as recited in claim 14, wherein each said non-wood layer is comprised of first quality Carbon Fiber/Kevlar Hybrid Fabric.

17. A skateboard deck, as recited in claim 14, wherein each said non-wood metal strip is comprised of titanium.

18. A skateboard deck comprising of plural stacked wood ply laminate layers, non-wood layers and metal strips said skateboard deck having a center axis with said non-wood layers being centered over said center axis and being placed between the wood layers when laminated, the length of non-wood layers being determined by the formula: p/2 ×3−L+1 wherein “p” is the number of wood layers and “L” is the overall length of said skateboard deck, the width of the non-wood layers for skateboard decks with four and five layers of wood being determined by the formula w/3×2+1 wherein “w” is the overall width of said skateboard deck and the width of non-wood layers for skateboard decks with six or more layers of wood being determined by the formula w/3×2−1 wherein “w” is the overall width of said skateboard deck.

19. A skateboard deck, as recited in claim 18, wherein each wood ply layer is less than or greater than or equal to 1/16″ thick.

20. A skateboard deck, as recited in claim 18, wherein each said non-wood layer is comprised of first quality Carbon Fiber/Kevlar Hybrid Fabric.

21. A skateboard deck comprising of plural stacked wood ply laminate layers, non-wood layers and a metal strip said skateboard having a center axis with said non-wood layers being centered over said center axis and being placed between the wood layers when laminated, the length of non-wood layers being determined by the formula: p/2 ×3−L+1 wherein “p” is the number of wood layers and “L” is the overall length of said skateboard deck, the width of the non-wood layers for skateboard decks with four and five layers of wood being determined by the formula w/3×2+1 wherein “w” is the overall width of said skateboard deck and the width of non-wood layers for skateboard decks with six or more layers of wood being determined by the formula w/3×2−1 wherein “w” is the overall width of said skateboard deck.

22. A skateboard deck, as recited in claim 21, wherein each wood ply layer is less than or greater than or equal to 1/16″ thick.

23. A skateboard deck, as recited in claim 21, wherein each said non-wood layer is comprised of first quality Carbon Fiber/Kevlar Hybrid Fabric.

24. A skateboard deck, as recited in claim 21, wherein each said non-wood metal strip is comprised of titanium.
